(19) United States
(12) Patent Application Publication
(10) Pub. No.: US 2003/0114203 A1
(43) Pub. Date: Jun. 19, 2003

(54) Battery connector for mobile phone

(76) Inventor: Dong Hee Lee, Seoul (KR)

Correspondence Address: Daniel F. Drexler, 55 Griffin South Road, Bloomfield, CT, 06002, US

(21) Appl. No.: 10/081,080

(22) Filed: Feb. 21, 2002

(30) Foreign Application Priority Data
Dec. 13, 2001 (KR) 2001-38505

(51) Int. Cl. H04B 1/38

(52) U.S. Cl. 455/572; 455/90; 455/550

(57) ABSTRACT

Provided is a battery connector installed to be connected with a battery of a mobile phone. The assembling efficiency of the battery connector can be improved by simplifying the configuration thereof. In order to enhance the durability, a plurality of plunger housings are formed on a body formed of a plastic material. A plunger in contact with a battery terminal is slidably inserted into each of the plurality of plunger housings. The plunger is supported by a spring made of a conductive material and the lower end of each of the plurality of plunger housings is covered by a base cover member, thereby bringing the plunger into elastic contact with the battery terminal. Also, the base cover member connected to the bottom plane of each of the plurality of plunger housings is adhered to a printed circuit board (PCB) of the mobile phone by soldering, thereby supplying power to various electronic elements of the PCB through the plunger, the spring and the base cover member.

### BACKGROUND OF THE INVENTION

1. Field of the Invention

The present invention relates to a battery connector for a mobile phone, and more particularly, to a connector installed at a battery connection part of a mobile phone body and being in contact with a battery terminal.

2. Description of the Related Art

A conventional battery connector 40 for a mobile phone is assembled such that a fixing part 42 is inserted into an interface connector body 41 installed inside a main body of a mobile phone, and an elastic contact part 43 integrally extending from one end of the fixing part 42 to be bent at an acute angle with respect to the fixing part 42, the center of the elastic contact part 43 being convexly bent upward, passes through the interface connector body 41 to project outside the main body of a mobile phone, as shown in FIG. 4.

Since the conventional battery connector 40 is formed by bending a thin-sheet strip, the elastic contact part 43 may be deformed when it is repeatedly applied to load, losing a restoring force for the fixing part 42, thereby resulting in a bad connection state with respect to the battery terminal.

Also, since the conventional battery connector formed of a thin-sheet strip, is constructed with complexity, it is difficult to assemble the battery connector with the connector body, lowering the assembling efficiency.

### SUMMARY OF THE INVENTION

To solve the above-described problems, it is an object of the present invention to provide a battery connector having improved manufacturability by simplifying its structure and improving an assembling efficiency, and having a longlasting lifetime by increasing its durability.

To solve the above object of the present invention, there is provided a battery connector for a mobile phone, installed in a main body of the mobile phone and contacting a battery terminal to supply power to a printed circuit board (PCB) of the mobile phone, the battery connector comprising: a body having a plurality of plunger housings; a plunger slidably installed in each of the plurality of plunger housings of the body; a base cover member having a cylindrical connection part fitted in the lower end of each of the plurality of plunger housings to close each of the plurality of the plunger housings, the bottom surface of the base cover member adhered to the PCB by soldering and made of a conductive material; and a spring biasing the plunger in the plunger housing against the bottom of the base cover member.

Therefore, since the battery connector according to the present invention has a plunger structure, elasticity can be maintained even when it is used for a long time, thereby prolonging a lifetime. Since the battery connector has a simplified structure, the assembling efficiency thereof is also enhanced.

### BRIEF DESCRIPTION OF THE DRAWINGS

The above objects and advantages of the present invention will become more apparent by describing in detail preferred embodiments thereof with reference to the attached drawings in which:

FIG. 1 is a perspective view of a battery connector according to the present invention, in which a battery is separated from a main body of a mobile phone;

FIG. 2 is an exploded perspective view of a battery connector according to the present invention;

FIG. 3 is a cross-sectional view taken along the line A-A shown in FIG. 1; and

FIG. 4 is a perspective view of a conventional battery connector.

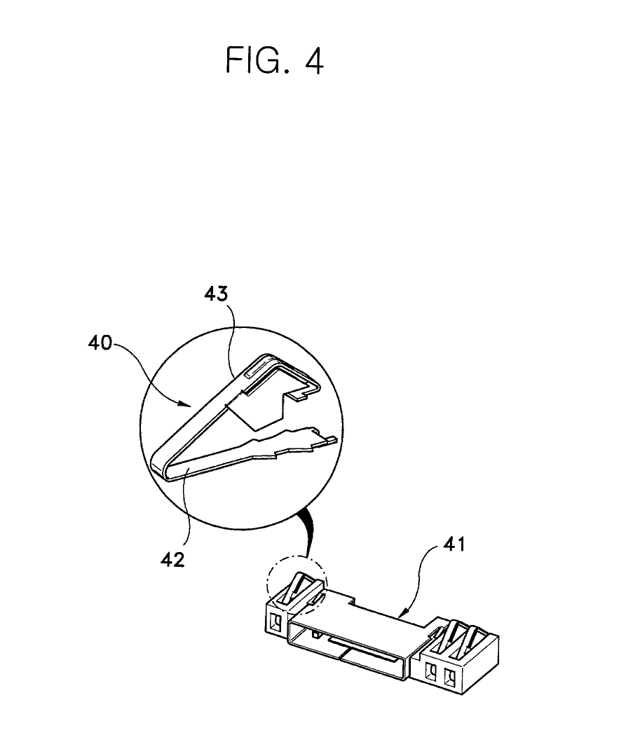

### DETAILED DESCRIPTION OF THE INVENTION

The present invention will now be described in detail with reference to a preferred embodiment.

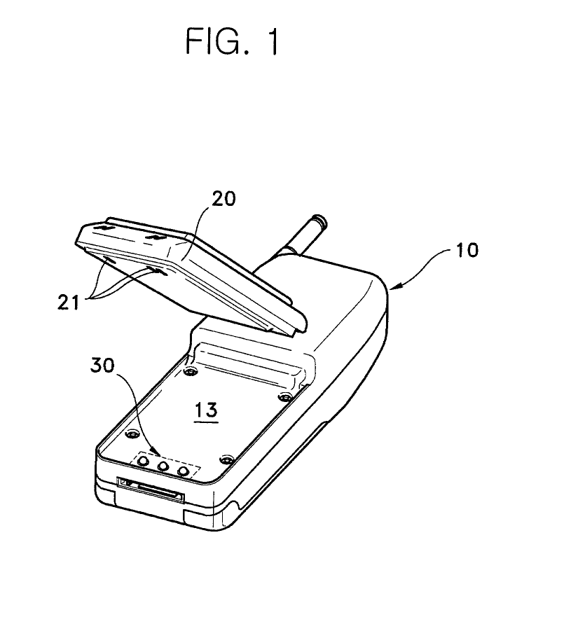

Referring to FIG. 1, reference numeral 10 denotes a main body of a mobile phone, reference numeral 20 denotes a battery detachably connected to the main body 10. A battery connector 30 according to the present invention, installed at a lower portion of a battery connecting portion 13 of the main body 10, contacts a terminal 21 of the battery 20 and supplies power to an electronic element (not shown) inside the main body 10.

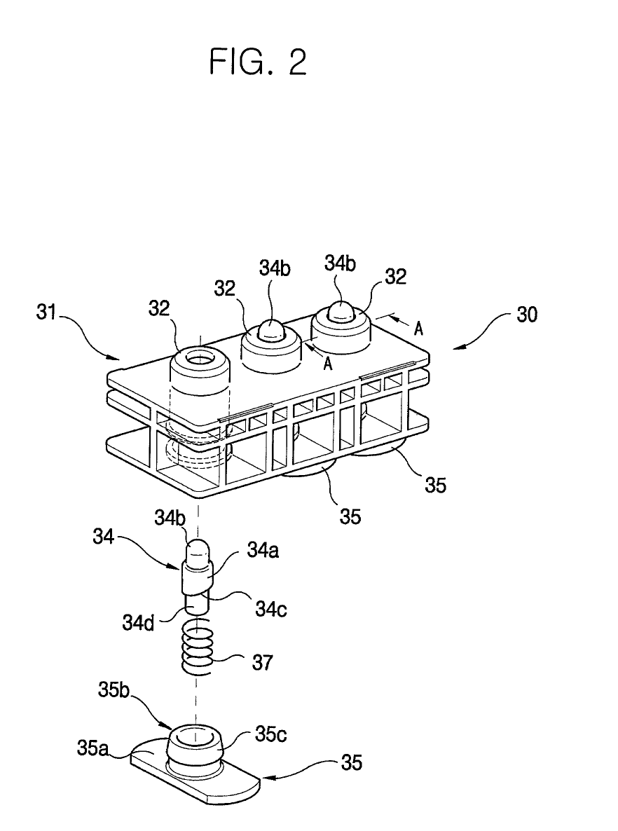

As shown in FIG. 2, the battery connector 30 according to the present invention includes a body 31 having a plurality of plunger housings 32. The housings 32 and the body 31 are integrally formed using a plastic material so that the upper portions of the plunger housings 32 project upward from the top plane of the body 31.

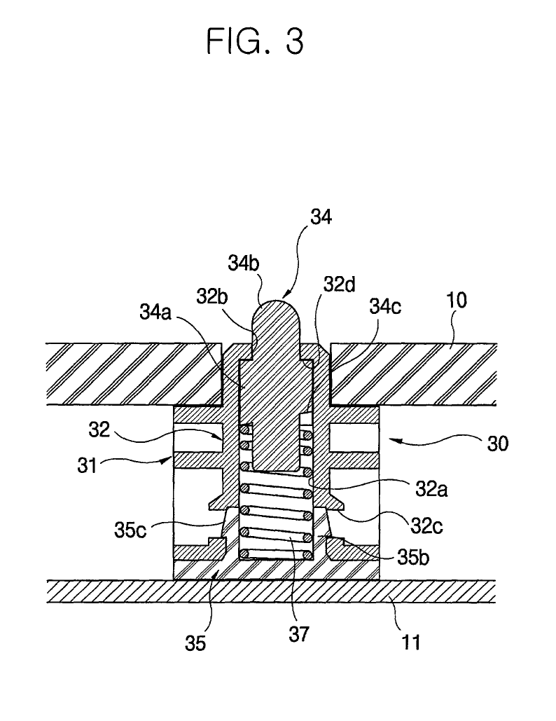

As shown in FIG. 3, each of the plurality of plunger housings 32 includes an axial bore 32a slidably accommodating a plunger 34, and an upper opening 32b having a diameter smaller than that the bore 32a coaxially connected to the bore 32a. A shoulder 32d is formed on the boundary between the bore 32a and the opening 32b.

The plunger 34 includes a guide portion 34a in slidably contact with the inner side wall of the bore 32a of each of the plunger housing 32, a contact portion 34b coaxially extending upward from the guide portion 34a and penetrating through the opening 32b of the plunger housing 32 to project to the plunger housing 32, and a spring fixing portion 34d coaxially extending downward from the lower end of the guide portion 34a, and into which a spring 37 is fitting inserted. The contact portion 34d has a hemispherical upper end in order to maintain a point contact with the battery terminal. A spring sheet surface 34c with which one end of the spring 37 is in contact at a boundary between the guide portion 34a and the spring fixing portion 34d, is inclined so that the force of the spring 37 acts on the plunger 34 bias.

A base cover member 35 is fitted in the lower end of the bore 32a of each of the plurality of plunger housings 32 so that the plunger 34 is supported by the spring 37. The base cover member 35 has a cylindrical connection part 35b extended upwardly on the top surface of a base plate 35a to be fitted in the lower end of the bore 32a. On the outer surface of the cylindrical connection part 35b is formed an annular hook 35c engaged with a coupling groove 32c formed on the side wall of the plunger housing 32. The base cover member 35 and the spring 37 are necessarily made of a conductive material such as a copper alloy.

The battery connector 31 according to the present invention is assembled such that the plunger 34 is inserted into the bore 32a of the plunger housing 32 with one end of the spring 37 fitted on the lower spring fixing portion 34d, and the lower end of the bore 32a is covered by the base cover member 35. The plunger 34 is pushed by the spring 37 so that the top surface of the guide portion 34a is in contact with the shoulder 32d of the plunger housing 32, that is, the contact portion 34b of the plunger 34 protrudes from the plunger housing 32.

As shown in FIG. 3, in the battery connector 30 according to the present invention, the bottom surface of the base cover member 35 is adhered to the surface of a printed circuit board (PCB) 11 in the body of the mobile phone by soldering, and the contact portion 34b of the plunger 34 protruding from the plunger housing 32 extends through an opening of the main body 10 of the mobile phone.

When the battery 20 is connected to the battery connecting portion 13 of the main body 10, the plunger is pushed in a state in which the terminal 21 of the battery 20 contacts the contact portion 34b of the plunger 34 projecting outside the main body 10. The spring 37 supporting the plunger 34 is contracted to allow the plunger 34 to slide in the plunger housing 32. Here, the battery 20 supplies electric power to the PCB 11 through the plunger 34, the spring 37 and the base cover member 35.

When the plunger 34 is restored by the spring 37 by detaching the battery 20 from the main body 10, the force of the spring 37 acts on the plunger 34 bias because the spring sheet surface 34c of the plunger 34 is inclined. Thus, the plunger 34 is smoothly raised inside the bore 32a of the plunger housing 32.

Since the battery connector according to the present invention is constructed in a spring-plunger manner, its durability is enhanced. In particular, since the respective elements are fittingly assembled, the structure of the battery connector is simplified, thereby improving the assembling efficiency and manufacturability.

What is claimed is:

1. A battery connector for a mobile phone, installed in a main body of the mobile phone and contacting a battery terminal to supply power to a printed circuit board (PCB) of the mobile phone, the battery connector comprising:
a body having a plurality of plunger housings;
a plunger slidably installed in each of the plurality of plunger housings of the body;
a base cover member having a cylindrical connection part fitted in the lower end of each of the plurality of plunger housings to close each of the plurality of the plunger housings, the bottom surface of the base cover member adhered to the PCB by soldering and made of a conductive material; and
a spring biasing the plunger in the plunger housing against the bottom of the base cover member.
